(19) United States
(12) Patent Application Publication
(10) Pub. No.: US 2020/0213095 A1
(43) Pub. Date: Jul. 2, 2020

(54) METHOD AND DEVICE FOR THE COMPUTER AIDED PROCESSING OF A RANDOM BIT PATTERN

(71) Applicant: Siemens Aktiengesellschaft, München (DE)

(72) Inventors: Hans Aschauer, München (DE); Steffen Fries, Baldham (DE)

(21) Appl. No.: 16/615,069

(22) PCT Filed: Apr. 20, 2018
(86) PCT No.: PCT/EP2018/060235

§ 371 Date: Nov. 19, 2019

(30) Foreign Application Priority Data
May 23, 2017 (EP) 17172518.7

(51) Int. Cl. H04L 9/06

(52) U.S. Cl. CPC H04L 9/0656

(57) ABSTRACT

A method for the computer-aided processing of a random bit pattern, the random bit pattern being provided in a traceable and secure manner and high flexibility of the random bit pattern being ensured is provided. Embodiments of the invention is advantageous over conventional methods because embodiments of the invention defines, in particular at a first point in time, all degrees of freedom or parameters (e.g., which data source should be used, cryptographic methods for the first cryptographic checksum, number of measurement values, data format of the measurement values, a length of the random bit pattern, a data format of the random bit pattern (32-bit numbers, 64 bit numbers)) for the random bit pattern in the first method data set and/or format data set. In particular, it is no longer possible to freely select the parameters at the second point in time.

### CROSS-REFERENCE TO RELATED APPLICATIONS

This application claims priority to PCT Application No. PCT/EP2018/060235, having a filing date of Apr. 20, 2018, which is based off of EP Application No. 17172518.7, having a filing date of May 23, 2017, the entire contents both of which are hereby incorporated by reference.

### FIELD OF TECHNOLOGY

The following relates to a method and a device for the computer-aided processing of a random bit pattern.

### BACKGROUND

In the definition of cryptographic methods, e.g. in the standardization of a cryptographic method, pseudo-random bit patterns (which may also be referred to as bit strings) are often required e.g. for the following purposes:
for defining S-boxes in block ciphers or hash methods
for defining prime numbers defining algebraic groups, in particular in asymmetric cryptographic methods
for defining elliptic curves.

In this case, these bits strings are intended to be part of a published definition.

In this case it is desirable or required that these bit strings be obtained in a manner that is traceable for a third party.

That is intended to prevent a weakness from being introduced into the cryptographic method as a backdoor as a result of a specific and only apparently random choice of the bit string.

### SUMMARY

An aspect relates to provide a method and a device for the computer-aided provision of random bit patterns.

In accordance with a first aspect, embodiments of the invention relate to a method for the computer-aided provision of a random bit pattern comprising the following method steps:
providing a first method data set and a format data set at a first point in time;
detecting measurement values at a second point in time, wherein
   the second point in time succeeds the first point in time,
   the measurement values fulfil a format defined by the format data set;
calculating the random bit pattern on the basis of the measurement values by means of a cryptographic function at a third point in time, wherein
   the third point in time is the second point in time or succeeds the second point in time;
   the cryptographic function is defined by the first method data set,
   a second method data set is generated at the third point in time,
   the first method data set and the random bit pattern are stored in an assigned manner in a second method data set;
providing and transmitting the second method data set at a fourth point in time.

Unless indicated otherwise in the following description, the terms “carry out”, “calculate”, “computer-aided”, “compute”, “ascertain”, “generate”, “configure”, “reconstruct” and the like relate to actions and/or processes and/or processing steps which change and/or generate data and/or convert the data into other data, wherein the data can be represented or be present in particular as physical variables, for example as electrical pulses. In particular, the expression “computer” should be interpreted as broadly as possible to cover in particular all electronic devices having data processing properties. Computers can thus be for example personal computers, servers, programmable logic controllers (PLCs), handheld computer systems, pocket PC devices, mobile radio devices and other communication devices which can process data in a computer-aided manner, processors and other electronic devices for data processing.

In association with embodiments of the invention, “computer-aided” can be understood to mean for example an implementation of the method in which in particular a processor performs at least one method step of the method.

In association with embodiments of the invention, a “processor” can be understood to mean for example a machine or an electronic circuit. A processor can be in particular a central processing unit (CPU), a microprocessor or a microcontroller, for example an application-specific integrated circuit or a digital signal processor, possibly in combination with a storage unit for storing program instructions, etc. A processor can for example also be an IC (Integrated Circuit), in particular an FPGA (Field Programmable Gate Array) or an ASIC (Application-Specific Integrated Circuit), or a DSP (Digital Signal Processor) or a graphic processing unit (GPU). Moreover, a processor can be understood to mean a virtualized processor, a virtual machine or a soft CPU. It can for example also be a programmable processor which is equipped with configuration steps for performing the stated method according to embodiments of the invention or is configured with configuration steps in such a way that the programmable processor implements the features according to embodiments of the invention of the method, of the component, of the modules, or of other aspects and/or partial aspects of embodiments of the invention.

In association with embodiments of the invention, a “storage unit” or “storage module” and the like can be understood to mean for example a volatile memory in the form of main memory (Random-Access Memory, RAM) or a permanent memory such as a hard disk or a data carrier.

In association with embodiments of the invention, “measurement values” can be understood to mean for example a measurable, determinable or retrievable variable. This can involve for example values that are provided and/or communicated in particular by a homepage or some other data source (e.g. web service, internet address, magazine). Measurement values can thus be, in particular, retrievable variables or values or physical variables.

In association with embodiments of the invention, “blockchain” can be understood to mean for example an implementation of a blockchain on the basis of bitcoin or Ethereum. In particular, for implementation details with regard to bitcoin, reference is made to [1], which is consulted by the person skilled in the art, if appropriate, in order to implement a specific realization for example in the context of embodiments of this invention.

In association with embodiments of the invention, a “module”, “component” and the like can be understood to mean for example a processor and/or a storage unit for storing program instructions. By way of example, the processor is specifically designed to execute the program instructions in such a way that the processor executes functions for implementing or realizing the method according to embodiments of the invention or a step of the method according to embodiments of the invention.

In association with embodiments of the invention, “providing” can be understood to mean for example public providing (that is to say providing accessible to arbitrary persons) of the corresponding data sets. This can be done, for example by means of a blockchain (e.g. bitcoin or Ethereum) in which the corresponding data sets are stored for example in one transaction or a plurality of transactions in one or a plurality of blocks of the blockchain. In this case, by way of example, the blocks can be communicated/transmitted to one or a plurality of nodes of the blockchain. Alternatively or additionally, the corresponding data sets can be provided for example by a time stamp service (e.g. by the corresponding data sets being transmitted to the time stamp service or blockchain and, in particular, the time stamp service or the blockchain providing these data sets again or transmitting them to some other receiver/node). Alternatively or additionally, the corresponding data sets can be provided for example by a publication service in digital form (e.g. as a digital document) or in analog form (e.g. as a paper magazine). Alternatively, the data sets each comprise a checksum of the data that are intended to be provided. Optionally, the data sets comprise for example a reference to a storage location or a data source (e.g. internet address) at which the corresponding data are stored. If the providing is realized for example by means of a blockchain in which in particular the data sets are stored in the transactions of a block/link, the providing results in the corresponding data sets in particular being distributed/communicated to the nodes of the blockchain since the blockchain is, in particular, a distributed database which is/has been realized. For example, by means of a peer-to-peer network architecture.

In association with embodiments of the invention, “transmitting” can be understood to mean for example transmitting a data set to a publicly accessible receiver (that is to say providing accessible to arbitrary persons) with the corresponding data sets. This can be done for example using a blockchain (e.g. bitcoin, Ethereum or some other public blockchain) in which the corresponding data sets are stored for example in one transaction or a plurality of transactions in one or a plurality of blocks of the blockchain and are communicated/transmitted to a receiver/node. Alternatively or additionally, the corresponding data sets can be provided for example by a time stamp service.

In association with embodiments of the invention, a “checksum”, for example the first cryptographic checksum or the second cryptographic checksum, can be understood to mean for example a cryptographic checksum or a cryptographic hash or hash value that is formed or calculated in particular by means of a cryptographic hash function by way of a data set. Furthermore, it can in particular also be understood to mean a digital signature or a cryptographic message authentication code.

In association with embodiments of the invention, “transaction” and “transactions” can be understood to mean for example a smart contract, a data structure or a transaction that stores in particular the data sets mentioned. In association with embodiments of the invention, “transaction” and “transactions” can for example also be understood to mean the data of a transaction of a link of a blockchain. A transaction data set or a transaction can comprise a program code or be a program code which realizes a smart contract, in particular. The method(s) according to embodiments of the invention can also be realized by means of the smart contract or the corresponding program code, wherein such a realization/implementation is platform-independent, in particular. In this case, it is also possible in particular for only a single or a plurality of method steps to be realized by a smart contract (e.g. determining the measurement values). In such a realization, by way of example, computationally intensive method steps can be calculated outside the blockchain (that is to say not using the virtual machine) and/or less computationally intensive method steps are carried out within the blockchain (that is to say by means of a smart contract executed by the virtual machine). In this regard, by way of example, detecting the measurement values and/or providing the data sets (e.g. first method data set and/or second method data set and/or format data set) can be realized by means of a smart contract. By way of example, calculating the random bit pattern can then be carried out outside the blockchain. For this purpose, by way of example, a corresponding smart contract can utilize a web service or the like in order to carry out the calculation (e.g. by utilizing a web service that offers a cryptographic function for data (e.g. measurement values)).

In association with embodiments of the invention, a “transaction data set” can for example also be understood to mean a transaction of a link/block of a blockchain.

In association with embodiments of the invention, a “program code” can be understood to mean for example control commands, program instructions, or control instructions, which are stored in particular in a transaction.

In association with embodiments of the invention, a “smart contract” can be understood to mean for example an executable program code. The program code is executable in particular on a virtual machine, wherein the virtual machine may have Turing completeness. The virtual machine can be realized/implemented for example by the blockchain itself (e.g. Ethereum) and/or the blocks with the transactions/smart contracts (that is to say the program code) of a blockchain are distributed in particular among a plurality of nodes of the blockchain.

In association with embodiments of the invention, “link” can be understood to mean for example a block of a blockchain, which is realized in particular as a data structure and may comprise in each case one of the transactions or a plurality of the transactions. A link can comprise for example indications concerning the variable (data variable in bytes) of the link, a block header, a transaction counter and one or a plurality of transactions [1]. The block header can comprise for example a version, a concatenation checksum, a transaction checksum, a time stamp, a proof-of-work verification and a nonce (one-off value, random value or counter used for the proof-of-work verification) [1].

In association with embodiments of the invention, a random bit pattern is calculated in particular analogously to a checksum, for example by means of a cryptographic function that calculates a cryptographic hash for the measurement values.

The method is advantageous to the effect for example of providing the random bit pattern in a traceable and secure manner and in the process ensuring a high flexibility of the random bit pattern. Embodiments of the invention are advantageous by comparison with conventional methods since it defines in particular at the first point in time all degrees of freedom or parameters (e.g. which data source is intended to be utilized, cryptographic methods for the first cryptographic checksum, number of measurement values, data format of the measurement values, a length of the random bit pattern, a data format of the random bit pattern (32-bit numbers, 64-bit numbers)) for the random bit pattern and/or a cryptographic method (which utilizes in particular the random bit pattern) in the first method data set and/or format data set. In particular, at the second point in time there is no longer freedom of choice with regard to the parameters. In particular, only the measurement values of the chosen parameters remain open up to this point in time, but the defining party has no influence on them (that is to say the party providing the first method data set and/or format data set).

The method is advantageous in particular to the effect that a temporal component is introduced into the method, which temporal component retrospectively allows the verifiability of the random bit pattern, without leaving for the defining party, in particular, any utilizable freedom of choice that might lead to a back door, for example. By way of example, embodiments of the invention make it possible to realize cryptographic methods and/or cryptographic parameters which are not suspected of having a back door, as is possible in conventional methods, in particular, in which a weak point is introduced into a cryptographic method as a result of a suitable choice of the random bit pattern.

As a result, the method is also advantageous to the effect of realizing in particular a direct publishability of the method and/or of the data source for the choice of a specific parameter of a method.

As a result, the method is also advantageous to the effect of defining parameters for a cryptographic method (e.g. for calculating elliptic curves) for example by means of the random bit pattern.

In particular, with regard to embodiments of the invention, “random” in association with the “bit pattern” means that the bit pattern itself is not predefined by the method. In particular, however, all necessary parameters are predefined by the method data set and the format data set (at the first point in time) in order to calculate the random bit pattern in a reproducible manner on the basis of the measurement values available at a later point in time (second point in time). Consequently, in particular the random bit pattern is not known or calculable before the second point in time, but the random bit pattern is calculable in a reproducible manner in particular starting from the second point in time (that is to say can be reproduced in particular on the basis of the measurement values).

In a first embodiment of the method, the format data set is stored in the first method data set or the first method data set comprises the format data set.

In a further embodiment, a first minimum time interval between the first point in time and/or the second point in time is predefined by the first method data set, and/or a second minimum time interval between the second point in time and/or the third point in time is predefined by the first method data set, and/or a third minimum time interval between the third point in time and/or the fourth point in time is predefined by the first method data set.

The method is advantageous to the effect of determining in particular the point in times in order for example not to retrieve a data source directly after the first point in time, even though this is not yet necessary at all for the method. In particular, an unnecessary bandwidth utilization of an internet connection can be avoided as a result.

In a further embodiment of the method, a first data source for the measurement values is defined by the first method data set.

The method is advantageous to the effect of predefining in particular a data source that provides measurement values having a specific random distribution/randomness. The data source can be for example an internet address, an indication for a newspaper (e.g. with indication of the issue, page and line indications), a register of births with a number of births in a specific town/city on one or more days, a cemetery plan with a number of gravestones in a row of gravestones on a burial ground. The measurement values can then be obtained for example directly by way of the data source or are detectable by way of a separate sensor/data source (a data source can in particular also be a sensor); by way of example, an aerial photograph could be used in the case of the number of gravestones. Moreover, by way of example, the type of measurement values or the type of measurement of the measurement values can be predefined in the first method data set. By way of example, only light gravestones and their dimensioning and the date(s) of death mentioned are used or, from the register of births, only the number of births of girls is taken into account.

In a further embodiment of the method, a minimum time duration of an availability of the measurement values is defined by the first method data set and/or a maximum time duration of an availability of the measurement values is defined by the first method data set.

The method is advantageous to the effect of ensuring, in particular, that the measurement values are available for a sufficiently long time or of ensuring, in particular, that measurement values are intended to be used only as long as it is possible to be certain that they will not change.

In a further embodiment of the method, providing the first method data set and/or the format data set and/or the second method data set is carried out by means of a blockchain and/or a time stamp service and/or a publication.

The method is advantageous to the effect of ensuring, in particular, that the data sets provided are invariable and/or that in particular a point in time of the providing is traceable.

In a further embodiment of the method, the first method data set and/or the format data set and/or the second method data set are/is provided in such a way as to be invariable.

The method is advantageous to the effect, in particular, of enabling the data sets not to be manipulated/altered.

In a further embodiment of the method, the measurement values can be detected in a reproducible manner (and the measurement values are not variable, in particular).

The method is advantageous to the effect, in particular, of providing the measurement values to the public and thus to all potential users.

In a further embodiment of the method, a second data source or further data sources is/are defined by the first method data set, and the second data source or the further data sources provide(s) the cryptographic function and/or the conversion function.

The method is advantageous to the effect, in particular, of providing the functions of trustworthy data sources (for example a trustworthy service such as e.g. a timestamp service or a blockchain service).

In accordance with a further aspect, embodiments of the invention relate to a method for the computer-aided verification of a random bit pattern comprising the following method steps:
receiving a second method data set, wherein the second method data set was determined by means of the method,
detecting the measurement values;
calculating a second cryptographic checksum for the measurement values by means of the cryptographic function defined by the first method data set;
comparing the second cryptographic checksum with the random bit pattern, wherein a control signal is provided depending on the checking result.

In accordance with a further aspect, embodiments of the invention relate to a first device for the computer-aided provision of a random bit pattern comprising:
a first providing module (310) for providing a first method data set and a format data set at a first point in time;
a first detecting module (320) for detecting measurement values at a second point in time, wherein
   the second point in time succeeds the first point in time,
   the measurement values fulfil a format defined by the format data set;
a first calculating module (330) for calculating the random bit pattern on the basis of the measurement values by means of a cryptographic function at a third point in time, wherein
   the third point in time is the second point in time or succeeds the second point in time;
   the cryptographic function is defined by the first method data set,
   a second method data set is generated at the third point in time,
   the first method data set and the random bit pattern are stored in an assigned manner in a second method data set;
a first communication module (340) for providing and transmitting the second method data set at a fourth point in time.

In a further embodiment of the device, the device comprises at least one further module or a plurality of further modules for carrying out the method according to embodiments of the invention (or one of the embodiments of said method) for the computer-aided provision of a random bit pattern.

In accordance with a further aspect, embodiments of the invention relate to a second device for the computer-aided verification of a random bit pattern comprising:
a second communication module (410) for receiving a second method data set, wherein the second method data set was determined by means of the method,
a second detecting module (420) for detecting the measurement values;
a second calculating module (430) for calculating a second cryptographic checksum for the measurement values by means of the cryptographic function defined by the first method data set;
a second comparison module (440) for comparing the second cryptographic checksum with the random bit pattern, wherein a control signal is provided depending on the checking result.

In a further embodiment of the device, the device comprises at least one further module or a plurality of further modules for carrying out the method according to embodiments of the invention (or one of the embodiments of said method) for the computer-aided verification of a random bit pattern.

Furthermore, a computer program product (non-transitory computer readable storage medium having instructions, which when executed by a processor, perform actions) comprising program instructions for carrying out the stated methods according to embodiments of the invention is claimed, wherein in each case one of the methods according to embodiments of the invention, all of the methods according to embodiments of the invention or a combination of the methods according to embodiments of the invention can be carried out by means of the computer program product.

In addition, a variant of the computer program product comprising program instructions for the configuration of a creating device, for example a 3D printer, a computer system or a production machine suitable for creating processors and/or devices, is claimed, wherein the creating device is configured with the program instructions in such a way that the stated devices according to embodiments of the invention are created.

Furthermore, a providing device for storing and/or providing the computer program product is claimed. The providing device is for example a data carrier that stores and/or provides the computer program product. Alternatively and/or additionally, the providing device is for example a network service, a computer system, a server system, in particular a distributed computer system, a cloud-based computer system and/or a virtual computer system, which stores and/or provides the computer program product such as in the form of a data stream.

This providing takes place for example as a download in the form of a program data block and/or instruction data block, such as a file, in particular as a download file, or as a data stream, in particular as a download data stream, of the complete computer program product. However, this providing can for example also take place as a partial download which consists of a plurality of parts and in particular is downloaded via a peer-to-peer network or is provided as a data stream. Such a computer program product is read into a system for example using the providing device in the form of the data carrier and executes the program instructions, such that the method according to embodiments of the invention is executed on a computer or configures the creating device in such a way that the devices according to embodiments of the invention are created.

### BRIEF DESCRIPTION

Some of the embodiments will be described in detail, with reference to the following figures, wherein like designations denote like members, wherein:

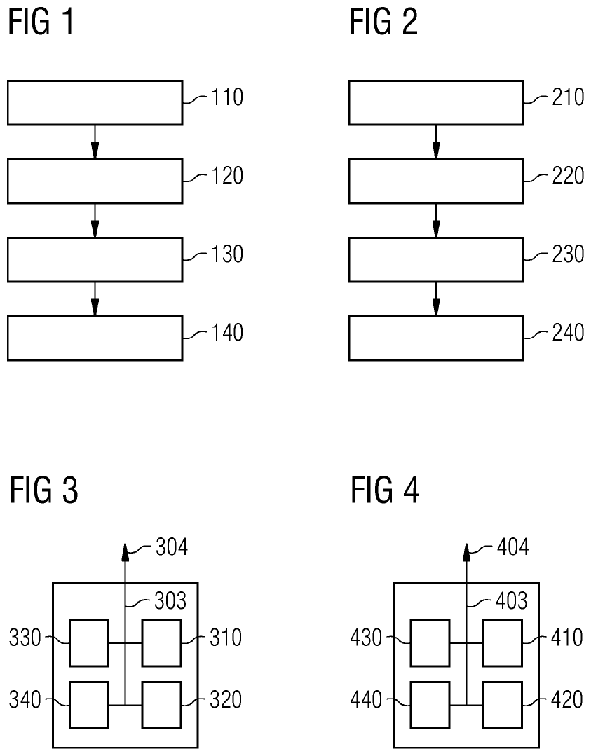

FIG. 1 shows a first exemplary embodiment of the invention as a flow diagram;

FIG. 2 shows a second exemplary embodiment of the invention as a flow diagram;

FIG. 3 shows a third exemplary embodiment of the invention; and

FIG. 4 shows a fourth exemplary embodiment of the invention.

In the figures, functionally identical elements are provided with the same reference signs, unless indicated otherwise.

### DETAILED DESCRIPTION

The following exemplary embodiments, unless indicated otherwise or already indicated, comprise at least one processor and/or a storage unit in order to implement or carry out the method.

Moreover, in particular a (relevant) person skilled in the art, is of course aware of all routine possibilities for realizing products or possibilities for implementation in the prior art, and so there is no need in particular for independent disclosure in the description. In particular, these customary realization variants known to the person skilled in the art can be realized exclusively by hardware (components) or exclusively by software (components). Alternatively and/or additionally, the person skilled in the art, within the scope of his/her expert ability, can choose to the greatest possible extent arbitrary combinations according to embodiments of the invention of hardware (components) and software (components) in order to implement realization variants according to embodiments of the invention.

A combination according to embodiments of the invention of hardware (components) and software (components) can occur in particular if one portion of the effects according to embodiments of the invention is brought about, in some embodiments exclusively, by special hardware (e.g. a processor in the form of an ASIC or FPGA) and/or another portion by the (processor- and/or memory-aided) software.

In particular, in view of the high number of different realization possibilities, it is impossible and also not helpful or necessary for the understanding of embodiments of the invention to name all these realization possibilities. In this respect, in particular all the exemplary embodiments below are intended to demonstrate merely by way of example a few ways in which in particular such realizations of the teaching according to embodiments of the invention could be manifested.

Consequently, in particular the features of the individual exemplary embodiments are not restricted to the respective exemplary embodiment, but rather relate in particular to embodiments of the invention in general. Accordingly, features of one exemplary embodiment can also serve as features for another exemplary embodiment, in particular without this having to be explicitly stated in the respective exemplary embodiment.

FIG. 1 shows a first exemplary embodiment of the invention as a flow diagram of the method according to embodiments of the invention for the computer-aided provision of a random bit pattern. The method may be realized by a transmitting node, in particular a blockchain node.

The method comprises a first method step 110 for providing a first method data set and a format data set at a first point in time. In this way, the data sets are published and are stored securely (e.g. publicly accessibly and in a manner safeguarded by means of a checksum). What is ensured in this case, in particular, is that the fact that the data sets were provided at the first point in time is traceable. This can be done for example by means of a blockchain, such as e.g. bitcoin or Ethereum. In this case, the data sets are stored in the transaction(s) of a block of the blockchain. For this purpose, by way of example, the corresponding transactions can comprise a timestamp indicating the first point in time. Since the content of the transactions of blocks of a blockchain is invariable, it is possible in this way, in particular, for the data sets to be provided in a simple manner. In other words, it is exemplary for the data sets to be provided with the integrity thereof being protected (e.g. by means of checksums), wherein the first point in time (that is to say the point in time of the providing) likewise together with the data sets is provided with the integrity thereof being protected (e.g. is stored as a further transaction or in the transaction(s)).

The method data set describes, for example, how a random bit string/bit pattern is intended to be generated, e.g. what data sources are used, what cryptographic methods are used for calculating the cryptographic checksums (e.g. first/second cryptographic checksum), when and for how long the data sources are available for detecting/retrieving the measurement values. The method data set also indicates, for example, how the random bit pattern is intended to be used for parameters of a cryptographic method (e.g. as a seed for a random number generator, as an S-box for a cryptographic method). By way of example, the method data set can indicate that the random bit pattern has a length of 512 bits. In this case, by way of example, the first 256 bits can serve as a private key for an asymmetric cryptographic method. Bits 257-350 can serve for example as a seed for a random number generator and bits 351-512 can be used as a starting value in the context of a challenge-response method. Alternatively, the method data set can indicate that parameters for elliptic curves are provided in an analogous manner by means of the random bit pattern.

The format data set describes, for example, how many measurement values are intended to be detected, what numerical representation (e.g. int, char, floating point) is required for the random bit pattern, and how the individual measurement values are intended to be conditioned (data format, data structure). By way of example, the format data set can also indicate a formatting or conversion function for conditioning the measurement values in order that the latter satisfy or meet the requirements defined by the format data set and/or method data set.

The format data set can be for example an (integral) part of the first method data set (e.g. can be stored in the latter, or the first method data set comprises a reference to the format data set) or can be realized as a separate data set.

The method comprises a second method step 120 for detecting measurement values at a second point in time, wherein the second point in time succeeds the first point in time and the measurement values fulfil a format (e.g. the examples mentioned for the format data set) defined by the format data set. In this case, the measurement values may be publicly accessible and are measurable or available in particular only after the first point in time and at the latest at the second point in time. The measurement values are not foreseeable at the first point in time, in particular.

The measurement values are measurable by or available from a first data source in particular publicly for a predefined period of time or starting from a specific point in time (e.g. second point in time). In particular, said measurement values are invariable or the corresponding measurement values can be measured/generated/retrieved in a reproducible manner. Thus in the case of the measurement values being detected repeatedly, the same measurement values are measured in a reproducible manner.

On the basis of said measurement values, the random bit pattern can be calculated in a reproducible manner starting from the second point in time by virtue of the measurement values being used directly, the measurement values being converted into a required data format and/or the measurement values being used as input data for a cryptographic/mathematical function.

For this purpose, the method comprises a third method step 130 for calculating the random bit pattern on the basis of the measurement values by means of a cryptographic function at a third point in time, wherein the third point in time is the second point in time or succeeds the second point in time (that is to say that the method step can be carried out at the second point in time at the earliest). Moreover, the cryptographic function is defined by the first method data set. Moreover, a second method data set is generated at the third point in time and the first method data set and the random bit pattern are stored in an assigned manner in the second method data set. Stored in an assigned manner means, in particular, that the corresponding data are assigned to the second method data set. This can be realized for example by these data being stored in the second method data set or the second method data set comprising checksums of the corresponding data and a data source (e.g. a server or an internet address) as to where these data are provided additionally being indicated.

In other words, the random bit pattern is a cryptographic checksum that is calculated for the measurement values.

The method comprises a fourth method step 140 for providing and transmitting the second method data set to a receiving node/receiver (e.g. to a blockchain node that realizes/implements in particular the method from FIG. 2) at a fourth point in time. Providing the second method data set can be carried out once again by means of a blockchain, for example. The second method data set may be invariable and for example also comprises the format data set or the data thereof. The fourth point in time succeeds the third point in time, in particular.

FIG. 2 shows a second exemplary embodiment of the invention as a flow diagram of the method according to embodiments of the invention for the computer-aided verification of a random bit pattern. The method may be realized by a receiving node, in particular a blockchain node.

The method comprises a first method step 210 for receiving a second method data set from a transmitting node/transmitter (for example a blockchain node that realizes/implements in particular the method from FIG. 1), wherein the second method data set was determined by means of the method described herein or was determined by the method illustrated in FIG. 1. Accordingly, the second method data set comprises the first method data set, the random bit pattern and optionally the format data set. In this case, the second method data set may have been transmitted to the receiving node in particular by means of a blockchain. Accordingly, the second method data set can be stored in transactions of a block of a blockchain.

The method comprises a second method step 220 for once again detecting the measurement values. The same measurement values as in FIG. 1 are thus detected.

The method comprises a third method step 230 for calculating a second cryptographic checksum for measurement values by means of the cryptographic function defined by the first method data set stored for example in the second method data set.

The method comprises a fourth method step 240 for comparing the second cryptographic checksum with the random bit pattern (in this case, the random bit pattern can also be regarded as a first checksum), wherein a control signal is provided depending on the checking result. By way of example, the checking result is provided by means of the control signal. If the checking result indicates that the second cryptographic checksum corresponds to the random bit pattern, then it is possible, by means of the control signal or the checking result, to control the fact that the cryptographic method determines its input parameters (e.g. seed, private key, starting values, parameters for elliptic curves) on the basis of the random bit pattern.

If the second cryptographic checksum does not correspond to the random bit pattern, then communicating the random bit pattern to the cryptographic method can be prevented by means of the control signal.

The methods illustrated in FIG. 1 and FIG. 2 constitute in particular a transmission method and a reception method, which can be realized in particular in each case by a node in a blockchain. It is also conceivable for the method to be defined by a smart contract, for example, or for the individual method steps to be realized in each case by means of a smart contract. Here the smart contract is executed for example by a virtual machine (e.g. in an Ethereum-based blockchain). In this case, the smart contract itself is distributed in particular among one or a plurality of nodes of the blockchain.

It is also conceivable, for example, for a node of the blockchain or a smart contract of the blockchain (that is to say a smart contract of a block of the blockchain) to realize both methods in FIG. 1 and FIG. 2. Such a node/smart contract could offer the provision and verification as services, for example, which are usable for free or against payment of a monthly fee.

In other words, embodiments of the invention realize a method (e.g. the methods from FIG. 1 and/or FIG. 2) in which the traceability of the random choice of a random bit pattern b is fully ensured, in particular for the inclusion of said random bit pattern in a publication or standardization of a cryptographic method.

What are relevant here, in particular, are the temporal aspects requiring for example a specific order and/or else time intervals between the individual steps of the method.

Firstly, in particular, the cryptographic method and/or the parameters necessary for the cryptographic method are/is defined completely in the first method data set and/or format data set, although without defining the random bit pattern (which is intended to be verifiably random).

At the first point in time T0, the first method data set and the format data set, which comprise for example the description (that is to say the requirements and the parameters) of the method or a hash value of these data, are published or transferred to a time stamp service or stored in a public blockchain or submitted to a standardization committee.

In particular, these data sets are accessible and traceable for a future verifier (that is to say someone who would like to verify the random bit pattern). Moreover, it is ensured, in particular, that these data sets were publicly available at the first point in time T0.

Likewise, at the first point in time T0, the format/properties (e.g. a list representation of the measurement values and the data format, e.g. string, integer, etc.) of the measurement values (e.g. the number thereof, the data format, etc.) and/or the order thereof are/is defined (e.g. by means of the format data set), wherein the measurement values are not yet known at the point in time T0 but become known at a later and well-defined point in time T1 (second point in time), and are then published in a manner checkable for future verifiers or publicly for a relatively long period of time.

It is assumed here that in particular the concrete (measurement) values cannot be influenced by anyone with tenable expenditure.

By way of example, the measurement values can be a list of share prices at the second point in time T1 (“closing price of the DAX30 shares at the Frankfurt Stock Exchange on Jun. 15, 2017 in alphabetic order”). A further possibility is the definition of the birth rate in a selection of specific geographical regions.

In a further variant, by way of example, a future block of a blockchain is defined for example as a first data source for the measurement values. By way of example, the hash value of the block k+30*24*6 in the (bitcoin) blockchain, which is expected approximately 30 days after the presently current block k, is defined as measurement value(s) or a portion of the transactions of the corresponding block is defined as measurement values. This can be defined for example in the first method data set. The block k may for example have been inserted into the blockchain at the first point in time and may comprise the first method data set and/or the format data set.

Likewise, a formatting function or conversion function is defined by the first method data set or the format data set and converts the measurement values x unambiguously into the format (e.g. converts strings into integer values).

Likewise, the function H, which calculates the random bit pattern on the basis of the measurement values, can be defined by the first method data set or the format data set. H can be e.g. a cryptographic hash function.

The first method data set likewise comprises these data e.g. description of the method and of the parameters, function H etc.

At the second point in time T1 or later (e.g. at the third point in time), a new version of the description of the method is created as second method data set, which corresponds to the original version (that is to say the first method data set) with the exception of the definition of the random bit pattern b. This version (that is to say the second method data set) is the defining version of the cryptographic method. This version, too, in particular by means of the random bit pattern b, can then be published in a verifiable manner, e.g. by way of a blockchain, a notary's office or else simply in a newspaper.

After the publication of the defining version, any interested party (“verifier”), starting from the fourth point in time T2, can check the randomness of the random bit pattern b by obtaining the list of the defined values (that is to say the measurement values) from an independent source (that is to say the first data source), conditioning said list in accordance with the formatting function (analogously to FIG. 1) and then generating the second checksum for the conditioned measurement values by means of the function H. The successful or unsuccessful verification can be documented e.g. in the context of standardization or as comments concerning a publication. This can be realized for example in an automated manner and semi-automatically by means of the control signal.

The length of the list of values (that is to say the number of measurement values) and also the temporal difference T1−T0 should be chosen such that a future verifier can be persuaded that the resulting random bit pattern is actually sufficiently random.

By way of example, if only one share price is indicated in the list (e.g. closing price of the Siemens share in one month starting from today), then it may be expected that the price in one month will vary in a range of 20 euro, the closing prices being rounded to whole five cent amounts. There are thus 20*20=400 possible price values; the entropy thereof is at best E=log 2(400)<9 bits. A future verifier will not be persuaded as to the randomness of the value as the result of this.

A simplified example is given below in which a verifier can be persuaded as to the randomness. By way of example, the following estimation can be made on the basis of the DAX30 share prices:

For T1−T0=four weeks the euro and cent values of the share prices ought to be so random and statistically independent that entropy of at least four bits can be estimated for each share.

Given 30 shares, therefore, entropy of at least 120 bits is obtained, which is sufficient for a cryptographic security level of 120 bits. In this case, the first data source can be an internet service for share prices or a homepage having share prices.

By way of example, at the point in time T0=Apr. 15, 2017 a first version of a cryptographic standard/method is published (that is to say the first method data set and the format data set), which defines (or is intended to define) a specific prime number, inter alia. A description is given therein of how a prime number is calculated with the aid of a random seed/starting value b (that is to say random bit patterns from FIG. 1 or FIG. 2) and a precisely defined deterministic random number generator. However, the random bit pattern/seed b is not yet defined.

What is additionally defined is that the closing prices of the DAX-30 shares on May 12, 2017 are intended to be used for calculating the random bit pattern b, and these are intended to be used in alphabetic order and are intended to be separated only by semicolons (“;”). The function H (that is to say the cryptographic function) is intended to be the hash function SHA-256.

At the point in time T1 (when the stock market closes on May 12, 2017), the following share prices are determined:

Adidas: 176.20 euro, Allianz: 172.80 euro, Vonovia: 35.95 euro
This is formatted as:

### Y=

“176.20;172.80;89.56;116.75;87.24;94.70;9.459;207.80;69.07; . . . ; 35.95”
(only a few values have been indicated for the sake of simplicity).

The random bit pattern or seed b is calculated as follows

b=SHA-256(Y)=23f31b42c056d19ed73de873 cc4b61c717b0caccb499689053a1d9 3524774f18

FIG. 3 shows a third exemplary embodiment of the invention as a first device for the computer-aided provision of a random bit pattern.

The device comprises a first providing module 310, a first detecting module 320, a first calculating module 330, a first communication module 340 and an optional first communication interface 304 (e.g. for communication with blockchain nodes), which are communicatively connected to one another via a first bus 303.

The device can for example additionally also comprise one further component or a plurality of further components, such as, for example, a processor, a storage unit, an input device, in particular a computer keyboard or a computer mouse, and a display device (e.g. a monitor). The processor can comprise for example a plurality of further processors, wherein for example the further processors in each case realize one or more of the modules. Alternatively, the processor realizes in particular all modules of the exemplary embodiment. The further component(s) can for example likewise be communicatively connected to one another via the first bus 303.

The processor can be for example an ASIC that was realized in an application-specific manner for the functions of a respective module or all modules of the exemplary embodiment (and/or of further exemplary embodiments), wherein the program component or the program instructions is/are realized in particular as integrated circuits. The processor can for example also be an FPGA that is configured in particular by means of the program instructions in such a way that the FPGA realizes the functions of a respective module or all modules of the exemplary embodiment (and/or of further exemplary embodiments).

The first providing module 310 is designed for providing a first method data set and a format data set at a first point in time.

The first providing module 310 can be implemented or realized for example by means of the processor, the storage unit and a first program component, wherein for example the processor is configured by execution of program instructions of the first program component or the processor is configured by the program instructions in such a way that the corresponding data sets are provided.

The first detecting module 320 is designed for detecting measurement values at a second point in time, wherein the second point in time succeeds the first point in time and the measurement values fulfil a format defined by the format data set.

The first detecting module 320 can be implemented or realized for example by means of the processor, the storage unit and a second program component, wherein for example the processor is configured by execution of program instructions of the second program component or the process is configured by the program instructions in such a way that the measurement values are detected.

The first calculating module 330 is designed for calculating the random bit pattern on the basis of the measurement values by means of a cryptographic function at a third point in time, wherein the third point in time is the second point in time or succeeds the second point in time and the cryptographic function is defined by the first method data set. Moreover, a second method data set is generated at the third point in time and the first method data set and the random bit pattern are stored in an assigned manner in the second method data set.

The first calculating module 330 can be implemented or realized for example by means of the processor, the storage unit and a third program component, wherein for example the processor is configured by execution of program instructions of the third program component or the processor is configured by the program instructions in such a way that the random bit pattern is calculated.

The first communication module 340 is designed for providing and transmitting the second method data set at a fourth point in time.

The first communication module 340 can be implemented or realized for example by means of the processor, the storage unit and a fourth program component, wherein for example the processor is configured by execution of program instructions of the fourth program component or the processor is configured by the program instructions in such a way that the second method data set is provided and transmitted.

The execution of the program instructions of the respective modules can be carried out in this case for example, by means of the processor itself and/or by means of an initialization component, for example a loader or a configuration component.

FIG. 4 shows a fourth exemplary embodiment of the invention as a second device for the computer-aided verification of a random bit pattern.

The device comprises a second communication module 410, a second detecting module 420, a second calculating module 430, a second comparison module 440 and an optional first communication interface 404 (e.g. for communication with blockchain nodes), which are communicatively connected to one another via a first bus 403.

The device can for example additionally also comprise one further component or a plurality of further components, such as, for example, a processor, a storage unit, an input device, in particular a computer keyboard or a computer mouse, and a display device (e.g. a monitor). The processor can comprise for example a plurality of further processors, wherein for example the further processors in each case realize one or more of the modules. Alternatively, the processor realizes in particular all modules of the exemplary embodiment. The further component(s) can for example likewise be communicatively connected to one another via the first bus 403.

The processor can be for example an ASIC that was realized in an application-specific manner for the functions of a respective module or all modules of the exemplary embodiment (and/or of further exemplary embodiments), wherein the program component or the program instructions is/are realized in particular as integrated circuits. The processor can for example also be an FPGA that is configured in particular by means of the program instructions in such a way that the FPGA realizes the functions of a respective module or all modules of the exemplary embodiment (and/or of further exemplary embodiments).

The second communication module 410 is designed for receiving a second method data set, wherein the second method data set was determined by means of the method described herein.

The second communication module 410 can be implemented or realized for example by means of the processor, the storage unit and a first program component, wherein for example the processor is configured by execution of program instructions of the first program component or the processor is configured by the program instructions in such a way that the second method data set is received.

The second detecting module 420 is designed for detecting measurement values.

The second detecting module 420 can be implemented or realized for example by means of the processor, the storage unit and a second program component, wherein for example the processor is configured by execution of program instructions of the second program component or the processor is configured by the program instructions in such a way that the measurement values are detected.

The second calculating module 430 is designed for calculating a second cryptographic checksum for the measurement values by means of the cryptographic function, wherein the cryptographic function is defined by the first method data set.

The second calculating module 430 can be implemented or realized for example by means of the processor, the storage unit and a third program component, wherein for example the processor is configured by execution of program instructions of the third program component or the processor is configured by the program instructions in such a way that the second cryptographic checksum is calculated.

The second comparison module 440 is designed for comparing the second cryptographic checksum with the random bit pattern, wherein a control signal is provided depending on the checking result.

The second comparison module 440 can be implemented or realized for example by means of the processor, the storage unit and a fourth program component, wherein for example the processor is configured by execution of program instructions of the fourth program component or the processor is configured by the program instructions in such a way that the comparison is carried out.

The execution of the program instructions of the respective modules can be carried out in this case for example by means of the processor itself and/or by means of an initialization component, for example a loader or a configuration component.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for the computer-aided provision of a random bit pattern comprising the following method steps:
providing a first method data set and a format data set at a first point in time;
detecting measurement values at a second point in time, wherein
the second point in time succeeds the first point in time,
the measurement values fulfil a format defined by the format data set;
calculating the random bit pattern on the basis of the measurement values by means of a cryptographic function at a third point in time, wherein
the third point in time is the second point in time or succeeds the second point in time;
the cryptographic function is defined by the first method data set,
a second method data set is generated at the third point in time,
the first method data set and the random bit pattern are stored in an assigned manner in a second method data set;
providing and transmitting the second method data set at a fourth point in time.

2. The method as claimed in claim 1, wherein the format data set is stored in the first method data set or the first method data set comprises the format data set.

3. The method as claimed in claim 1, wherein
a first minimum time interval between the first point in time and/or the second point in time is predefined by the first method data set, and/or
a second minimum time interval between the second point in time and/or the third point in time is predefined by the first method data set, and/or
a third minimum time interval between the third point in time and/or the fourth point in time is predefined by the first method data set.

4. The method as claimed in claim 1, wherein a first data source for the measurement values is defined by the first method data set.

5. The method as claimed in claim 1, wherein
a minimum time duration of an availability of the measurement values is defined by the first method data set and/or
a maximum time duration of an availability of the measurement values is defined by the first method data set.

6. The method as claimed in claim 1, wherein providing the first method data set and/or the format data set and/or the second method data set is carried out by means of a blockchain and/or a time stamp service and/or a publication.

7. The method as claimed in claim 1, wherein the first method data set and/or the format data set and/or the second method data set are/is provided in such a way as to be invariable.

8. The method as claimed in claim 1, wherein the measurement values are detected in a reproducible manner.

9. The method as claimed in claim 1, wherein the format data set defines a conversion function used to bring the measurement values into the format.

10. The method as claimed in claim 1, wherein
a second data source or further data sources is/are defined by the first method data set,
the second data source or the further data sources provide(s) the cryptographic function and/or the formatting function.

11. A method for the computer-aided verification of a random bit pattern comprising the following method steps:
receiving a second method data set, wherein the second method data set was determined by means of the method as claimed in claim 1,
detecting the measurement values;
calculating a second cryptographic checksum for the measurement values by means of the cryptographic function defined by the first method data set;
comparing the second cryptographic checksum with the random bit pattern, wherein a control signal is provided depending on the checking result.

12. A device for the computer-aided provision of a random bit pattern comprising:
a providing module for providing a first method data set and a format data set at a first point in time;
a detecting module for detecting measurement values at a second point in time, wherein
the second point in time succeeds the first point in time,
the measurement values fulfil a format defined by the format data set;
a calculating module for calculating the random bit pattern on the basis of the measurement values by means of a cryptographic function at a third point in time, wherein
the third point in time is the second point in time or succeeds the second point in time;
the cryptographic function is defined by the first method data set,
a second method data set is generated at the third point in time,
the first method data set and the random bit pattern are stored in an assigned manner in the second method data set;
a communication module for providing and transmitting the second method data set at a fourth point in time.

13. A device for the computer-aided verification of a random bit pattern comprising:
a communication module for receiving a second method data set, wherein the second method data set was determined by means of the method as claimed in claim 1,
a detecting module for detecting the measurement values;
a calculating module for calculating a second cryptographic checksum for the measurement values by means of the cryptographic function defined by the first method data set;
a comparison module for comparing the second cryptographic checksum with the random bit pattern, wherein a control signal is provided depending on the checking result.

14. A computer program product, comprising a computer readable hardware storage device having computer readable program code stored therein, said program code executable by a processor of a computer system to implement a method comprising program instructions for carrying out the methods as claimed in claim 1.

15. A computer program product comprising program instructions for a creating apparatus that is configured by means of the program instructions to create the device as claimed in claim 12.

16. A providing device for the computer program product as claimed in claim 14, wherein the providing device stores and/or provides the computer program product.
